(19) United States
(12) Patent Application Publication
(10) Pub. No.: US 2015/0103700 A1
(43) Pub. Date: Apr. 16, 2015

(54) GROUP TWO-WAY RADIO SYSTEM FOR PROVIDING TEMPORARILY EMERGENTLY EXPANDING COMMUNICATION RANGE AS A PORTABLE DISPATCH SYSTEM WITH NO AVAILABLE SIGNAL REPEATER INVOLVED

(71) Applicant: UNICATION GROUP/Unication Co., Ltd., New Taipei City (TW)

(72) Inventor: SHIH-TSENG YEH, New Taipei City (TW)

(73) Assignee: UNICATION GROUP/Unication Co., Ltd., New Taipei City (TW)

(21) Appl. No.: 14/054,768

(22) Filed: Oct. 15, 2013

(51) Int. Cl. H04B 7/155; H04B 7/212

(52) U.S. Cl. CPC H04B 7/15507; H04B 7/212
USPC 370/279

(57) ABSTRACT

A portable or vehicle radio of a two-way radio system for use by a group is generally in direct call mode as a generic radio. Once a communication range is needed to be expanded under a condition of no available repeater, a group commander is able to designate a two-way radio most suitable for functioning as a signal repeater according to GPS location through over-the-air programming or manual control to expand the communication range. The signal repeater retransmits signals being received through time division multiple access (TDMA) over a same channel at different time slots that provides a function of expanding a communication range as a conventional dual-band repeater transmitting signals over uplink and downlink bands does. Therefore, the present invention functions as a generic radio, so as to become a mobile disposal system for providing temporary, emergent and expanded communication range when an emergency is occurred.

### BACKGROUND OF THE INVENTION

1. Field of the Invention

The present invention relates to a group two-way radio system for providing temporarily emergently expanding communication range as a portable dispatch system with no available signal repeater involved, and more particularly to a system and method for enabling a group utilizing an appropriate two-way radio to quickly establish a repeater for emergently expanding communication range for the group two-way radio, that is designating one of the two-way radios (including portable or vehicle radios) according to a global positioning system (GPS) location through the manual control or an over-the-air programming (OTAP) command, under a condition of no repeater or the repeater being damaged when the group moves or is in need of expanding a communication range of the group for carrying out a task.

2. Related Art

For a general group (police, medical, military, or emergency rescue groups) carrying out a task (or duty) in a place where a stationary signal repeater is not set or a signal repeater is broken, such as the wilds of a mountain, or in a place where communication infrastructure is damaged by earthquakes, typhoons, floods or landslides, or the group carrying out a battle mission, the group two-way radios in such a place are often used in a manner of direct call to perform one to one or one to more regional real-time communication; Moreover, if a large communication range necessitated in the task place is known in advance (including that a signal repeater is broken by a disaster in a disaster site), the group will beforehand carry and set a traditional two channel repeater to extend the communication range. However, most of the emergencies (as situations mentioned above) occurred without previous warning, and the communication range for a task is not to be predicted. As a result, a commander is not able to control a real situation of a disaster site instantaneously and cannot efficiently command and dispatch the rescue crew and machines and tools because of the location that is out of the efficient communication range, whereby missing the best rescue time and making the disaster worse and worse.

In the situations mentioned above, utilizing traditional group two-way radios is not capable of resolving the problem of temporarily expanding the communication range because traditional two-way radios 100 and 200 communicate with each other often by a manner of direct call (talk around mode) from radio to radio (as shown in FIG. 1), wherein an effective communication range 101 is only within a radius R1 drawn from the two-way radio. When the two-way radio 200 moves beyond the communication range 101 of the two-way radio 100, a traditional dual-band repeater or a repeater 300 is required to re-transmit signals through frequency division multiple Access (FDMA, Rx F1 and Tx F2) in order to expand the original communication range 101 into a communication range 301 of a radius R2 drawn from the repeater 300 (as oblique lines shown in FIG. 1).

Traditional dual-band repeaters 300 include a stationary type and a portable type. The stationary repeater device tends to be damaged by disasters; the portable repeater device is needed to be additionally brought and therefore tends to be forgotten or brought in insufficient quantity for use, thereby causing inconvenience.

Furthermore, the traditional dual-band repeater 300 is required to have a duplexer which increases the volume and weight of the repeater, and thus makes the dual-band repeater 300 inconvenient to be carried (the repeater generally is a car-carried type repeater). Besides, where to set the traditional repeater is always troublesome, especially considering a frequently change of location for the task.

Still further, another problem of the traditional repeater 300 is that it needs two bands that are needed to be additionally assigned for avoid interfering repeater performance in the field. So, uplink and downlink bands are required to have their minimum frequency interval; that is, it takes time to apply for the two bands and costs more for frequency usage.

### SUMMARY OF THE INVENTION

In view of the drawbacks that traditional group two-way radio system utilizing dual-band repeaters to extend the communication range as mentioned above, it is imperative to provide an improved group two-way radio system of which a two-way radio is generally in direct call mode, but is capable of being designated as a signal repeater by a group commander or user according to a location of the radio through an over-the-air programming (OTAP) command or manual control for retransmitting signals so as to provide a portable dispatch system for temporarily and emergently expanding the communication range.

Accordingly, an object of the present invention is to provide a group two-way radio for temporarily expanding a communication range under a condition of no repeater or the repeater being damaged for which a group commander or user is able to designate a two-way radio from the multiple portable or vehicle radios as a signal repeater (one channel in time division multiple access (TDMA) mode) through manual control or an OTAP command, in order to solve a problem that the two-way radios are not capable of communicating in direct call mode because of an expanding task area.

Another object of the present invention is to provide a group two-way radio system which enables a group commander to designate a second section repeater when a communication range of a signal repeater as being firstly designated is failed to cover an expanding task area so as to expand the communication range to such an extent that is three times a communication range of the signal repeater in direct talk.

The group two-way radio system for providing a portable dispatch system intended to temporarily emergently expand a communication range under a condition of no available signal repeater, where a group of utilizing two-way radios and moving frequently from one place to another place to carry out a task under a condition of no repeater or the repeater being damaged, according to locations of users of the group, is capable of designating one of the two-way radios from a request of a group commander to function as a signal repeater through manual control or an over-the-air programming (OTAP) command, so as to emergently expand the communication range for the two-way radios of the group subject to a move of the group for carrying out the task; and wherein the group two-way radio system is performed by steps comprising:

a. the group commander designating at least one of the two-way radios at a most appropriate location for relaying according to global positioning system (GPS) location of each user of the group displayed on a screen of the two-way radio;

b. the group commander requesting the at least one of the two-way radios (the designated two-way radio) to switch from a direct call mode to a one channel repeater mode through manual control or the OTAP command so as to function as the signal repeater that retransmits signals through time division multiple access (TDMA) communication protocol over a same channel at different time slots;

c. the designated two-way radio then transmitting a notice or OTAP command in a all call manner to all of the two-way radios on the same channel to request to switch to the one channel repeater mode;

d. the other two-way radios (in the Group's) received the notice to communicate in TDMA communication protocol being manually or automatically switched from the direct call mode to the one channel repeater mode for receiving and transmitting signals in TDMA communication protocol over the same channel at different time slots; and

e. the other two-way radio after switching to the one channel repeater mode automatically transmitting an acknowledgement (Ack) message of already in one channel repeater mode to the signal repeater (the designated two-way radio) or/and the two-way radio of the group commander.

Accordingly, the system and method of the present invention is capable of designating one or multiple of the two-way radios to be as a signal repeater, so as to provide a function of expanding a communication range as a conventional dual-band repeater (uplink/downlink frequency) does, whereby having the advantages of carrying less devices and providing a portable dispatch system for a temporary and emergent need of expanding a communication range without the need to apply for two matched frequencies.

### BRIEF DESCRIPTION OF THE DRAWINGS

FIG. 1 is a schematic disposition of a traditional group two-way radio system;

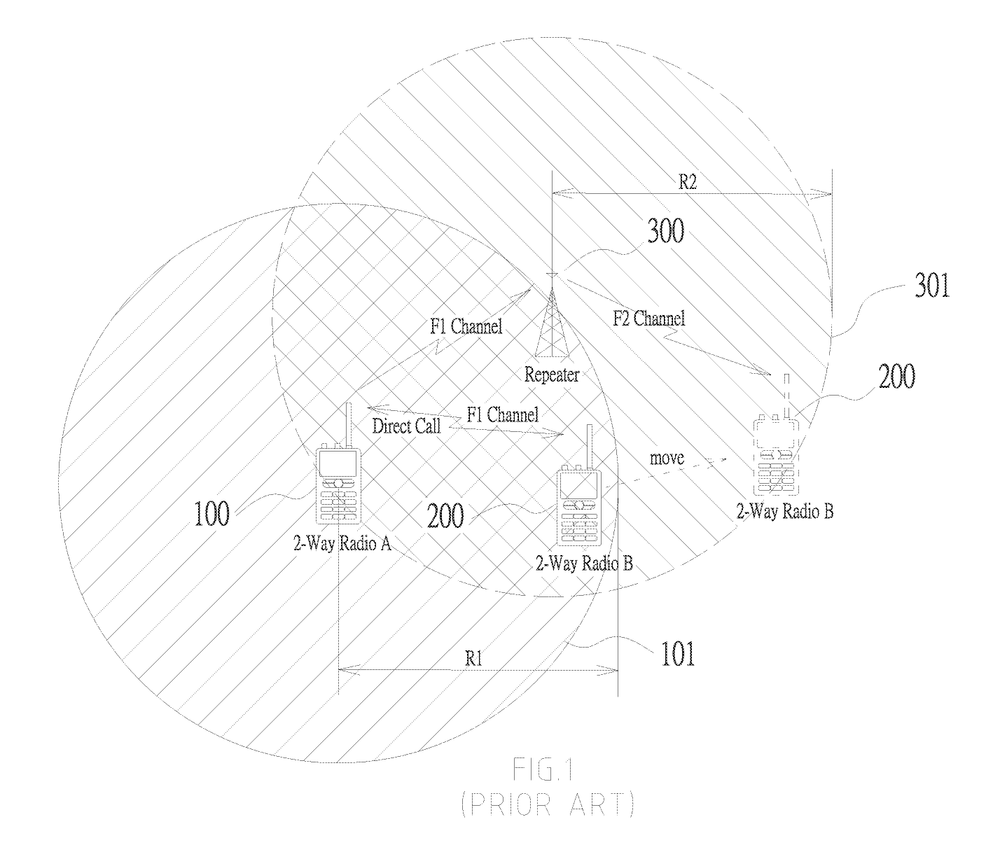

FIG. 2 is a flow chart of a method for performing a group two-way radio system of the present invention;

FIG. 3 is a schematic disposition of the group two-way radio system in accordance with one embodiment of the present invention; and

FIG. 4 is a schematic disposition of the group two-way radio system in accordance with another embodiment of the present invention.

### DESCRIPTION OF THE PREFERRED EMBODIMENTS

For better and further knowledge and understanding of the device and efficacy of the present invention, embodiments are hereby given with detailed descriptions in cooperation with the attached drawings below.

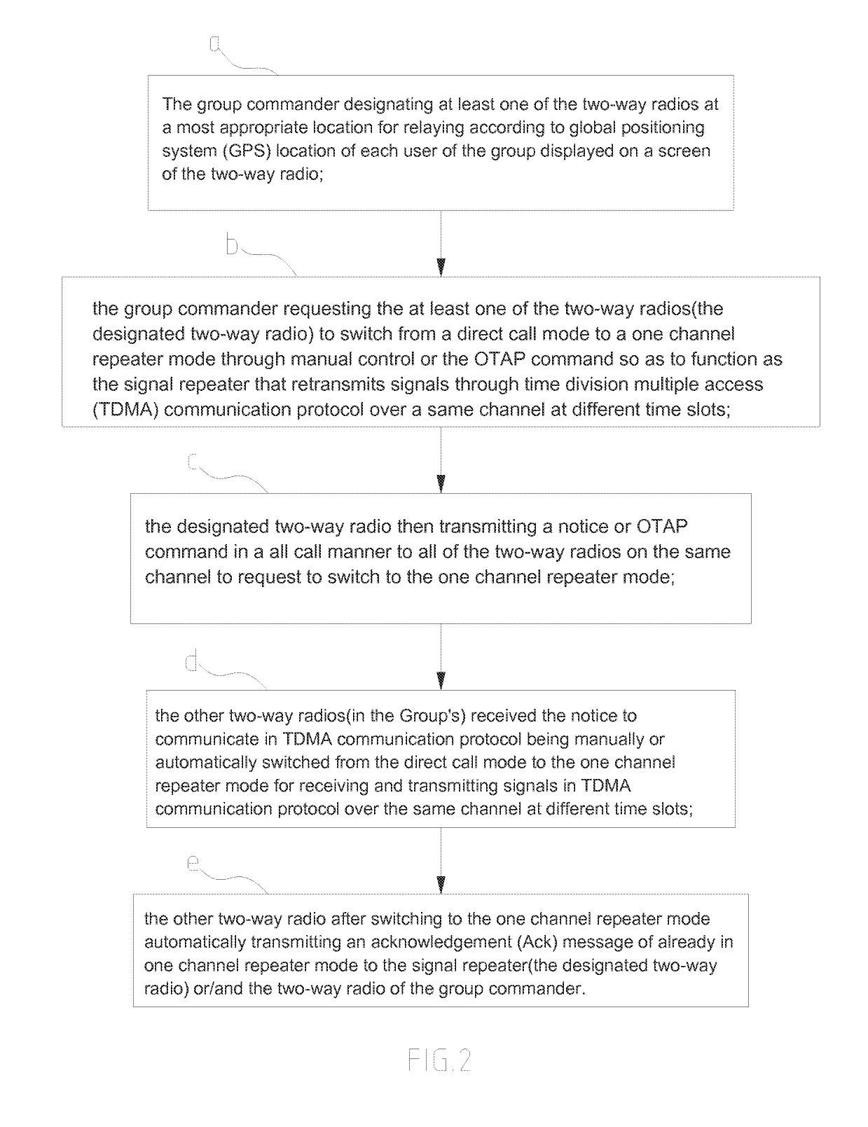

Referring to FIG. 2, the present invention discloses a group two-way radio system for providing temporarily emergently expanding communication range as a portable dispatch system with no available signal repeater involved. A group of users utilizing two-way radios to communicate in a task when moving frequently from one place to another place and needing to expand the communication range emergently under a condition of no repeater or the repeater being damaged, according to locations of users of the group, is capable of designating one of the two-way radios from a request of a group commander to function as a signal repeater through manual control or an over-the-air programming (OTAP) command so as to emergently expand the communication range for the two-way radios of the group subject to a move of the group for carrying out the task, wherein the group two-way radio system is performed by steps comprising:

a. the group commander designating at least one of the two-way radios at a most appropriate location for relaying according to global positioning system (GPS) location of each user of the group displayed on a screen of the two-way radio of the group commander;

b. the group commander requesting the at least one of the two-way radios to switch from a direct call mode to a one channel repeater mode through manual control or the OTAP command so as to function as the signal repeater that retransmits signals through time division multiple access (TDMA) communication protocol over a same channel at different time slots;

c. the designated two-way radio then transmitting a notice or OTAP command to all of the two-way radios on the same channel to request to switch to the one channel repeater mode;

d. the two-way radio received the notice of communicating in TDMA communication protocol being manually or automatically switched from the direct call mode to the one channel repeater mode so as to communicate with the other two-way radios; and

e. the two-way radio after being switched to the one channel repeater mode automatically transmitting an acknowledgement (Ack) message to the signal repeater or/and the two-way radio of the group commander (including a portable radio, vehicle radio, or a console).

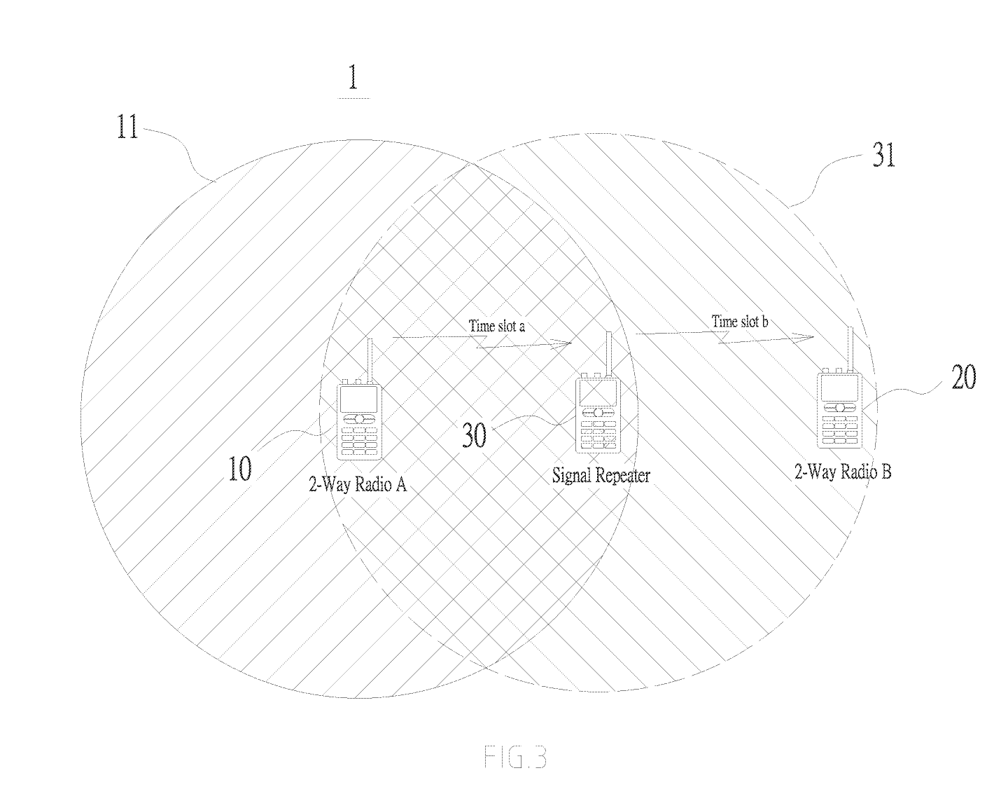

Referring to FIG. 3, when the group two-way radio system 1 is used under a condition of no available repeater, and the two-way radios of the group are out of a communication range for a direct call, the group commander is able to use his/her two-way radio 10 to designate one of the two-way radios 20 located at an appropriate place to be a signal repeater 30 through the OTAP command. The signal repeater 30 is within a direct communication range 11 of the group commander (the two-way radio 10), and is most preferably located at a farthest distance from the group commander within the direct communication range 11. Therefore, the communication range of the two-way radio 10 is expanded into a communication range 31 of the signal repeater 30 to cover the two-way radio 20.

The two-way radio designated as the signal repeater 30 first transmit a notice or OTAP command in a all call manner to all of the two-way radios 10 and 20 on the same channel to request to switch to the one channel repeater mode for communication in TDMA communication protocol. The signal repeater 30 is allowed to remain at where it is or to be carried and moved with the group users. Furthermore, the signal repeater 30 is capable of automatically switching to the one channel repeater mode after transmitting the notice to switch communication mode three times, or after receiving the Ack messages from several of the other two-way radios 20.

When either one of the two-way radios 20 receives the notice from the signal repeater 30, the two-way radio 20 receiving the notice is to be switched manually by the user or be switched based on the OTAP command to communicate in TDMA communication protocol. Moreover, said two-way radio 20 will transmit an Ack message to the signal repeater 30 or/and the group commander (the two-way radio 10) to enable the signal repeater 30 to switch to the one channel repeater mode upon receipt of the Ack message, and to enable the group commander to know who of the users not yet receive the notice so that the group commander can call them individually.

As mentioned above, in the step of designating the two-way radio as the signal repeater 30 by the group commander, the group commander is able to find out from a screen of the group commander's two-way radio by a built-in radio location display function which one of the two-way radios is most suitable for being the signal repeater 30. Furthermore, the group commander is capable of monitoring positions of the users from the screen of the two-way radio at any time, whereby to notice another one of the two-ways to function as a new signal repeater or to change the current signal repeater through manually control or the OTAP command according to the communication range or the move of the users. Furthermore, when no one is in communication with each other (i.e. not in the process of transmitting), the signal repeater 30 is allowed to call other users of the group so as to perform voice communication with all of the two-way radios 10 and 20 of the group.

A receiving channel utilized by the signal repeater 30 for signal transmission communication service between the multiple two-way radios 10 and 20 at least includes one of Rx time slot a, Rx time slot c, and Rx time slot d in TDMA format, where a transmitting channel for the signal repeater 30 is at Tx time slot a.

The receiving channel for communication between the multiple two-way radios 10 and 20 that switch to one channel repeater mode at least includes one of Rx time slot a˜Rx time slot d in TDMA format, and the transmitting channel is at Tx time slot a.

As mentioned above, when the two-way radio 20 is notified to switch to the one channel repeater mode through the OTAP command, the two-way radio 20, based on the OTPA command from the signal repeater 30, is capable of communicating over the receiving channel at Rx time slot b corresponding to the Tx time slot b of the signal repeater 30.

As the embodiments mentioned above, when either one of the two-way radios 20 switched to the one channel repeater mode is not capable of receiving calibration signals (such as dummy signals or other similar signals) from the signal repeater 30 over a predetermined period of time, the two-way radio 20 is deemed to be out of the communication range 31 of the signal repeater 30. Accordingly, after confirmation that the two-way radio 20 is out of the communication range 31 of the signal repeater 30 an alert or/and a blinking alarm signal is automatically transmitted to the two-way radio 20 to remind a user thereof The predetermined period of time is defined by pulse per second (PPS).

The signal repeater 30 is allowed to remain at a current site for use. After the task is completed or the group moves to another location, either one of the two-way radios 10 or 20 is capable of transmitting a command through OTAP to restore GPS information of the signal repeater 30 so as to help the group find or move the signal repeater 30.

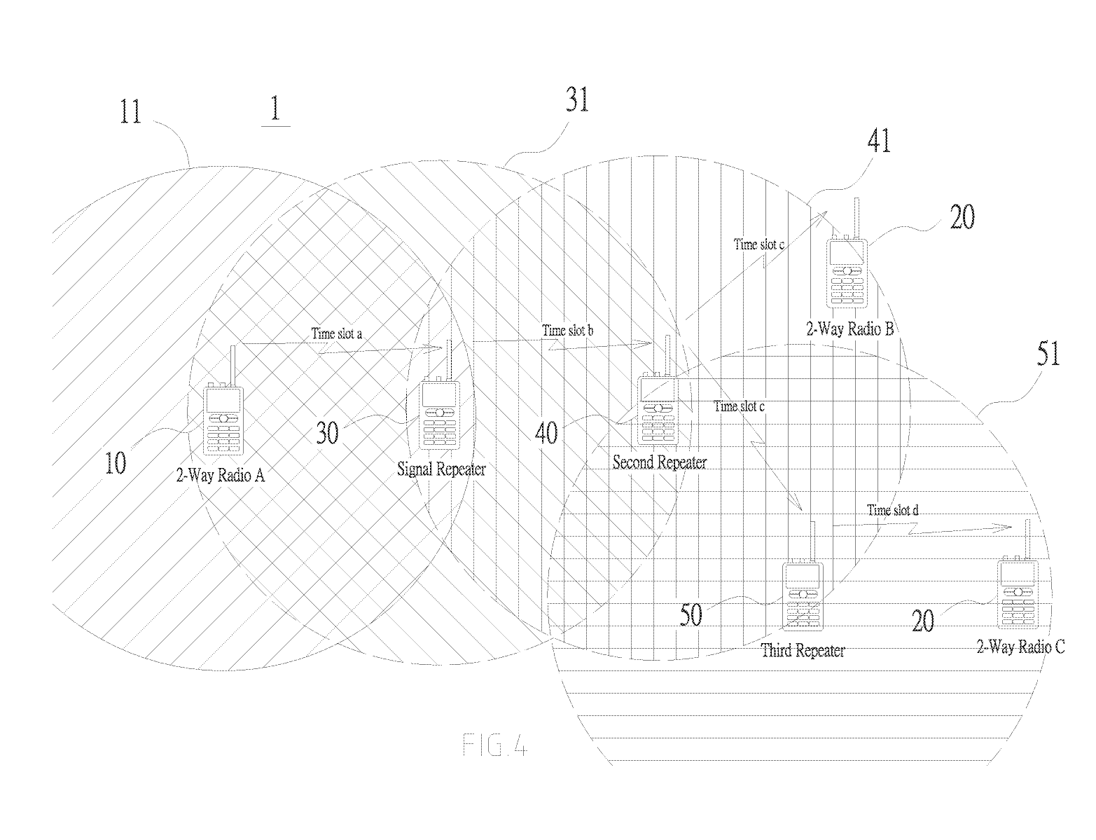

Referring to FIG. 4 which furthers the disposition of the group two-way radio system in FIG. 3, when an task area of the group continuously expands to an extent that is over the communication range 31 of the signal repeater 30, the group commander is able to designate one or multiple of the two-way radios at an appropriate location for relaying as a second section repeater 40 (or rear section repeater). The second section repeater 40 is positioned within the communication range 31 of the signal repeater 30 (or front section repeater) and is most preferably located at a farthest distance from the group commander (the two-way radio 10) within the communication range 31. In this manner, as shown in FIG. 4, the entire communication range from the group commander to the farthest two-way radio 20 (B) covering the communication range 41 of the second section repeater 40 and the communication range 31 of the signal repeater 30 is three times the direct communication range 11. Likewise, the second section repeater 40 is capable of notifying all the other two-way radios 20 in a all call manner to request the other two-way radios 20 to add a corresponding time slot for receiving signals from the second section repeater 40, whereby to enable to further expand a communication range from the group commander to the other two-way radio 20.

Furthermore, a receiving channel utilized by the second section repeater 40 for signal transmission communication service at least includes one of Rx time slot a, Rx time slot c, and Rx time slot d in TDMA format, where a transmitting channel for the second section repeater 40 is at Tx time slot a. Moreover, Rx time slot of the second section repeater 40 is same as Tx time slot of the signal repeater 30 (first section), while Tx time slot of the second section repeater 40 is different than Tx time slot of the signal repeater 30.

As mentioned above and so forth as shown in FIG. 4, the system is allowed to further set a third section repeater 50 or more repeaters continuously so as to add a communication range 51 for the system. A receiving channel utilized by the third section repeater 50 for signal transmission communication service at least includes one of Rx time slot a, Rx time slot b, and Rx time slot d in TDMA format, where a transmitting channel for the second section repeater 40 is at Tx time slot a.

The time slot a˜time slot d as mention above for the signal repeater 30, the second section repeater 40 and the third section repeater 50 are all at a same frequency.

It is understood that the invention may be embodied in other forms within the scope of the claims. Thus the present examples and embodiments are to be considered in all respects as illustrative, and not restrictive, of the invention defined by the claims

What is claimed is:

1. A group two-way radio system for providing temporarily emergently expanding communication range as a portable dispatch system with no available signal repeater involved, where a group of utilizing two-way radios to communicate in a task when moving frequently from one place to another place and needing to expand the communication range emergently under a condition of no repeater or the repeater being damaged is capable of designating one of the two-way radios from a request of a group commander, according to locations of users of the group, to function as a signal repeater through manual control or an over-the-air programming (OTAP) command so as to expand the communication range for the two-way radios of the group when needs to move the groups for carrying out duties; and wherein the group two-way radio system is performed by steps comprising:
a. the group commander designating at least one of the two-way radios at a most appropriate location for relaying, according to a global positioning system (GPS) location of each user of the group displayed on a screen of the radio of the group commander;
b. the group commander requesting the at least one of the two-way radios to switch from a direct call mode to the one channel repeater mode through manual control or the OTAP command so as to function as the signal repeater which is then to retransmit signals through time division multiple access (TDMA) communication protocol over a same channel at different time slots;
c. the designating two-way radio then transmitting a notice or OTAP command in an all call manner to all of the two-way radios on the same channel to request to switch to the one channel repeater mode;
d. the other two-way radios received the notice of communicating in TDMA communication protocol being manually or automatically switched from the direct call mode to the one channel repeater mode for receiving and transmitting signals in TDMA communication protocol over the same channel at different time slots; and
e. the other two-way radios after switching to the one channel repeater mode automatically transmitting an acknowledgement (Ack) message of already in one channel repeater mode to the signal repeater or/and the two-way radio of the group commander.

2. The system of claim 1, wherein the signal repeater uses a receiving channel for communication in TDMA format at a time slot that is different than a time slot of a transmitting channel.

3. The system of claim 1, wherein the two-way radio switching to the one channel repeater mode uses a receiving channel for communication in TDMA format at a time slot that is same as a time slot of a receiving channel of the signal repeater but is different than a time slot of a transmitting channel of the two-way radio.

4. The system of claim 1, wherein when one of the two-way radios switching to the one channel repeater mode is not capable of receiving calibration signals from the signal repeater over a predetermined period of time, said two-way radio is deemed to be out of the communication range of the signal repeater for which an alert or/and a blinking alarm signal is automatically transmitted to said two-way radio to remind a user thereof after confirmation that said two-way radio is out of the communication range of the signal repeater.

5. The system of claim 4, wherein the predetermined period of time is defined by a pulse per second (PPS).

6. The system of claim 1, wherein the signal repeater is allowed to remain at a place suitable for relay, and after the task is completed or when the group moves to another location, any one of the two-way radios is capable of transmitting a command through OTAP to restore GPS information from the signal repeater so as to help the group find or move the signal repeater.

7. The system of claim 1, wherein a second signal repeater is designated by the steps same as the signal repeater being designated, a receiving channel of the second signal repeater having a time slot same as a time slot of a transmitting channel of the signal repeater, and a transmitting channel of the second repeater having a time slot different from the time slot of the transmitting channel of the signal repeater.

8. The system of claim 1, wherein the two-way radio designated as the signal repeater is allowed to call other users of the group when no one is in communication so as to perform voice communication with all of the two-way radios of the group.

9. The system of claim 1, wherein the two-way radio of the group commander is capable of displaying locations of all of the users of the group on a screen thereof, whereby the group commander is able to change or add a designation of the signal repeater by the OTAP command at any time according to the change of the communication range or the move of the group.
